(19) United States
(12) Patent Application Publication
(10) Pub. No.: US 2010/0052333 A1
(43) Pub. Date: Mar. 4, 2010

(54) Wast water energy system and method

(76) Inventor: John Andrews, Middleburg, VA (US)

Correspondence Address: Nash & Titus, LLC, 21402 Unison Road, Middleburg, VA, 20117, US

(21) Appl. No.: 12/583,789

(22) Filed: Aug. 26, 2009

Related U.S. Application Data
(60) Provisional application No. 61/190,164, filed on Aug. 26, 2008.

(51) Int. Cl. H02K 7/18

(52) U.S. Cl. 290/1 A

(57) ABSTRACT

A waste water energy system and method for producing electric power using waste water. Waste water from a waste water source is provided to one or more electric power generating devices that utilize waste water in and for the production of electric power.

This application claims priority of provisional application No. 61/190,164 filed Aug. 26, 2008.

### BACKGROUND OF THE INVENTION

The present invention is directed to a system and method for the production of electric power by utilizing energy from waste water.

### FIELD OF THE INVENTION

The present invention is directed to the production of electric power by utilizing waste water from waste water sources in connection with one or more electric power generating devices such as a water turbine, a gas turbine, and a steam turbine. The capture of energy from waste water to produce electric power along with the reduction of discharge or effluent into our waterways is beneficial to the environment.

### BRIEF DESCRIPTION OF RELATED ART

The energy crisis in the early 1970's, the recent skyrocketing fossil fuel prices, and the fear of global warming have created a need for significant innovation in the area of green energy. A lack of practical solutions and any reasonable prospects of efficient and robust green technologies that can be used in any geographic location where there is civilization have created a need for efficient, environmentally friendly and reasonably priced energy for individuals and communities regardless of location.

A number of green energy innovations exist. However, there are limitations to these systems in terms of where they can be used. One such green energy system is a wave energy conversion system that converts wave energy within a wave medium into electrical energy as described in U.S. Pat. No. 7,385,301. The system is an underwater device which derives power from buoyancy variations arising from changes in pressure caused by waves and/or changes in the level on the surface above and which reacts against a platform that changes level in accordance with tidal level changes. Although this type of energy system produces green energy, it is restricted in use to a plant near a large body of water.

Another green energy system that exists is a wind energy plant as described in U.S. Pat. No. 7,385,301. However, there are also limitations of this system in terms of where it can be used because there are areas where wind is not constant or prevalent.

Heretofore the enormous amount of power available from the byproducts of the world's waste water treatment plants has been largely ignored. Waste water treatment plants can exist wherever there is civilization. Therefore, it was the task of the present invention to create a green energy production system and process that can be placed in any geographical location where people use water and produce waste water. It was also a task of the present invention to provide a green energy system which is not limited by geographical location, i.e. ocean, consistent wind currents, etc.

Conventional disposal of waste water is as follows (reference to FIG. 1): water 1 from a water source (WS) 20 such as an aquifer, a river or lake is treated in a water treatment plant (WTP) 21 and the treated water 2 is sent to a municipality (M) 22 for use. Waste water 3 generated by the municipality (M) 22 is sent to a waste water treatment plant (WWTP) 23 for cleaning. Waste water effluent 4 is then discharged back into the water source (WS) 20. No energy from the waste water is recovered to make electricity. Water is simply lightly to extensively treated and put back into the natural water sources, a very expensive process with no gain for the community. There are some power generation plants that have used waste water for purposes of cooling only.

The system and process of the present invention utilizes discharge waste water from waste water treatment plants in the generation of electricity, thus potentially reducing millions of gallons per day of effluent being discharged in the waterways and thereby contributing to the cleanup of our major water resources such as, for example, the Chesapeake Bay.

When facilities of the invention are constructed within a “Power Service Area”, it would allow the Public Utilities to shut down existing non-green or inefficient power plants and possibly obtain ‘carbon credits’ in return.

Further, the system and process of the invention substantially reduces overall nutrients such as nitrogen and phosphorus as well as other organic compounds that typically are present in water coming from waste water treatment plants. By running this waste water though a gas turbine or steam generating process as described in the present system, the contaminants are greatly reduced into less harmful or no harmful byproducts.

In essence, the present invention utilizes a waste water source and one or more electric power generating devices that require an input of water or steam to produce electric power, wherein the water is waste water and the steam is waste water converted to steam from a waste water source. Suitable electric power generation devices that can utilize an output of waste water from a waste water source are: (i) a water turbine, (ii) gas turbine such as a steam injected gas turbine or water injected gas turbine, and (iii) steam turbine receiving steam generated from an HRSG (heat recovery steam generator). These elements are oriented between the entity, such as a municipality or industrial plant(s), that produce waste water and a regional power grid or onsite power grid.

Further, locating the facilities in the population centers where the demand for power is the greatest, reduces the loading on the regional power grids and will eliminate or reduce the need for constructing new power lines to import power from outside the population centers. The invention will also indirectly contribute to our national security and reliability of the public power systems by having multiple plants situated throughout the Power Demand/Population Centers, which are producing the waste water.

Therefore, an object of the present invention is to utilize waste water to produce electric power that is clean, to reduce the amount of waste water returning to a water source and to further reduce contaminants in waste water before it returns to the environment.

It is another object of the invention to reduce the discharge of effluent into waterways, and in doing so, reduce excess organic compounds and harmful nutrient discharge which would lead to eutrophication of the waterways, reduce green house gas associated with energy production, producing pure water in the process.

It is still another object of the invention to make a major contribution to self sustainability of cities in terms of energy around the world.

These and other objects will become more readily apparent and can be attained by the system and method of the present invention.

### SUMMARY OF THE INVENTION

The present invention relates to a system and method for harnessing energy from waste water and converting it to electric power outputs and/or generating electric power outputs with gas turbines or steam turbines operating with waste water for use internally in an onsite power grid or for sending to a regional power grid. Waste water from a waste water source is provided to one or more electric power generating devices that take an input of the waste water and produce electric power output(s).

### BRIEF DESCRIPTION OF THE FIGURES

FIG. 1 is a schematic representation of the waste water energy system according to one embodiment of the invention utilizing a water turbine and a combined cycle plant as electric power generating devices.

### DETAILED DESCRIPTION

In the system of the present invention, the waste water effluent 4 is not sent back to the water source but rather the energy it possesses is utilized for the production of electric power and further used in the power production process.

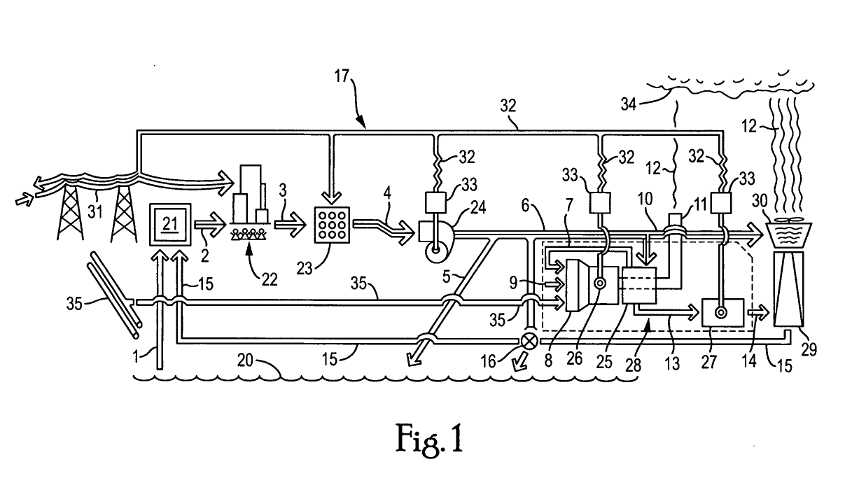

As shown in FIG. 1, the waste water energy method typically involves a number of steps. Optionally a water turbine (WT) 24 is installed in the discharge outfall pipes from one or more waste water treatment plants (WWTP) 23 where the appropriate feet of head is available where the turbine can extract over 90% of the energy from the waste water. The water turbine 24 may be sized to accommodate a portion of or the entire waste water effluent 4 flow from the WWTP 23 and will power a generator 33 to produce electric power (EP) 32, i.e. hydropower.

Treated waste water 6 that is diverted from the discharge line of the Water Turbine 24 is then sent on to additional electric power generating device(s). If all of the waste water 6 is not needed, excess waste water 5 is sent back to the water source WS 20. As shown in FIG. 1, the treated waste water 6 is sent in part to a combined cycle power plant 28. The combined cycle power plant 28 is a combination of (i.) a Steam Injected Gas Turbine (SIGT) 26 with a generator (G) 33, (ii) a heat recovery steam generator (HRSG) 25 and (iii) a Steam Turbine (ST) 27 with a generator 33. Both the SIGT 26 and the ST 27, with the aid of the HRSG 25, produce electric outputs (EP) 32. As also shown in FIG. 1, a second part of the waste water 10 from the water turbine 24 is sent to the cooling tower (CT) 30 for cooling purposes. Optionally, the water turbine portion of this system can be eliminated if there is not enough vertical drop in the location.

The combined cycle power plant is understood to be a combination of a steam (or water) injected gas turbine SIGT, a heat recovery steam generator HRSG and steam turbine ST.

In the combined cycle power plant in FIG. 1, a portion of the waste water converted to steam in the HRSG 25 and used in the steam injected gas turbine 26 is sent to the atmosphere (A) 34 through an exhaust stack 11 as vapor 12 and the balance of the waste water converted to steam in the HRSG 25 is sent via a steam pipe 13 to power the Steam Turbine (ST) 27 for the production of electric power (EP) 32.

Exhaust steam 14 from the Steam Turbine 27 is captured in a Condenser (C) 29 to produce clean or pure water 15. Clean water is recycled to the steam plant (for use in the HRSG 25 and SIGT 26) or released to the water treatment plant (WTP) 21, reducing the amount of water required from the water source 20 for the municipality 22. A control valve 16 is shown in FIG. 1 that permits a technician to divert variable portions of clean water 15 to the WTP 21, HRSG 25 and SIGT 26, and/or the WS 20 as desired to fit site specific conditions.

In addition to a combined cycle power plant 28, alternative configurations that include one or more of the electric power generating devices mentioned above can be used with the proviso that the electric power generating devices selected have the ability to utilize waste water for the production of electricity.

In another embodiment, waste water 1 from the waste water source 20 is sent directly to the cooling tower 30 for cooling purposes. The cooling tower blow down is also treated and the treated waste water can be recycled back to the cooling tower again as “make-up” or sent to the gas turbine, HRSG or other boiler device for the production of energy.

Water Turbines: The water turbine(s) is preferably a Francis Water Turbine manufactured by General Electric. This type of turbine extracts more than 90% of the energy from the water and is very efficient. Other water turbines may be used as well that harness a clean and renewable energy. Although it is preferable for the system and process to use a water turbine for maximum energy production and for transporting water from the waste water treatment source, a water turbine is an optional feature. It is especially useful when the waste water treatment plant is remote from or elevationally above the gas turbine or combined cycle power plant.

Gas Turbine: Different types of gas turbines are acceptable electric power generating devices for use in the invention. The gas turbine can be a steam or water injected gas turbine or any other gas turbine that can utilize waste water. Gas turbines are available from sources such as GE®, Siemens®, Hitachi® or other reputable sources. The preferred steam injected gas turbine is a part of a combined cycle power plant and is available from GE Power Systems® and is designated as the H-Series or the H System™. The H System™ achieves 60% fuel efficiency.

Combined Cycle Plant: The combined cycle plant is a combination of (i.) a Steam Injected Gas Turbine SIGT with a generator, (ii) a heat recovery steam generator HRSG and (iii) a Steam Turbine ST with a generator. As shown in FIG. 1, in the combined cycle plant 28 (HRSG 25, SIGT 26 and ST 27), water 6 enters the HRSG 25 where it is heated to produce steam 12. Some of the steam 12 is sent to the nozzle 8 of the SIGT 26 via a closed loop 7 to cool the SIGT 26. Natural gas from a natural gas line (NG) 35 and an air intake 9 is also sent to/received in the nozzle 8 of the SIGT 26 to power the SIGT to produce the EP 32. Exhaust heat from the SIGT is used by the HRSG to convert water 6 into steam to feed to the ST 27 for the generation of EP 32.

Steam Turbine: The steam turbine ST described for use in the system is any of a number of steam turbines on the market that have the ability to use the steam from a HRSG or other electric power generating device that produces steam. It should be understood that when a combined cycle plant is used, the steam turbine is a feature of the combined cycle plant.

Condenser: The condenser 29 that receives steam from the steam turbine can be a water cooled surface condenser in combination with an evaporative cooling tower 30, an air cooled condenser or a hybrid of both. Condensate can be recycled back to the combined cycle power plant, sent back to the water treatment plant 21 for reuse, or it can be sent back to the water source 20 or some combination of these uses. In the case where a water cooled surface condenser 29 is utilized, some of the water will be evaporated into the atmosphere in the evaporative cooling tower 30. A water cooled condenser is more energy efficient.

All of the components of this System are separately available on the market and in use in facilities all over the world. None of the components have ever been used with waste water from a waste water treatment plant.

Water Source: In the present invention, the water source is a waste water source such as a waste water treatment plant for a municipality, industrial plant, factory, or polluted waterway. Waste water, as the term is used herein is defined as water exiting from the waste water source that has been filtered to remove solid particles. Other secondary treatments to the waste water to remove phosphorous, nitrogen or other selected contaminants may or may not be required depending on the electric power generating devices used. An input of waste water is defined as waste water in the form of liquid or steam.

Multiple waste water sources may be used in the system as long as together they produce the required amount of waste water necessary to run all of the power generating equipment employed. In order to take advantage of economies of scale, it is preferable that a waste water source produce at least 5 million gallons or more of water per day to feed into a single steam injected gas turbine when that type of turbine is used.

It should be understood that each turbine includes a generator wherein it produces electric power outputs that are exported 17 to an electricity receiving device such as a grid or a Auxiliary and Supplemental Power Source (ASPS). A grid can be a regional power grid RPG or on onsite power grid.

Heat generated from the operation of the steam turbine condensers will be collected by cooling water and transferred to the ambient air through the use of a mechanical draft, evaporative cooling tower. A low-profile, 12 cell tower can be used. The source of water for the cooling tower make-up may be treated waste water from a water treatment plant or facility. The water is recirculated through each cell crossing paths with an ambient air stream drawn up by fans through the recirculating water. Heat is dissipated as a result of the evaporation of a portion of the cooling water. Water losses to the air stream or “drift” will be minimized through the use of height-efficiency mist eliminators. The mist eliminators also control any deposition resulting from any dissolved solids in the drift and the release of any chemical additives used to prevent foam formation and algae growth in the release of any chemical additives used to prevent foam formation and algae growth in the tower. A portion of the recirculating cooling water called cooling tower blowdown will be purged and recycled to the waste water treatment plant. An additional benefit will be a net reduction in the amount of treated waste water released into rivers and other waterways. This reduction will result in the removal of nitrates and phosphates from the rivers, bays, lakes and other waterways.

With the use of the system, greenhouse gases will be 30% lower than a new coal fired power plant and up to 50% lower than an older equivalent sized coal plant. Other harmful emissions associated with coal plants such as mercury and heavy metal will never be emitted.

Having generally described this invention, a further understanding can be obtained by reference to certain specific examples which are provided herein for purposes of illustration only and are not intended to be limiting unless otherwise specified.

### Example 1

The Example 1 is an embodiment of the process of the invention that incorporates a water turbine and a combined cycle power plant as electric power generating devices. A condenser is also utilized.
Water is taken from a Water Source WS such as River, Lake, Reservoir, Wells etc. and treated in a Water Treatment Plant WTP and distributed to the Municipality M.
Electricity is imported to the Municipality M from the Regional Power Grid RPG.
Sanitary waste generated by the Municipality is sent to a Waste Water Treatment Plant WWTP where it is processed to remove and/or reduce physical, chemical and biological contaminants. In traditional systems, the Treated Waste Water is discharged back into the River WS.
The Waste Water Energy Process in one embodiment of the invention intercepts the Treated Waste Water as it is discharged from the Waste Water Treatment Plant WWTP and feeds it to a Water Turbine WT which produces an Electric Power output EP.
Once the Water Turbine WT has extracted all of the available Energy from the Treated Waste Water, the Waste Water is diverted in part to a Heat Recovery Steam Generator HRSG and in part to a cooling tower (water cooled condenser configuration). The HRSG transfers the Heat Energy from the Exhaust produced by a Steam Injected Gas Turbine SIGT, to the Waste Water, which creates Steam.
A portion of the steam from the Heat Recovery Steam Generator HRSG is fed through a closed loop system and injected into the Steam Injected Gas Turbine SIGT along with the combustion air and natural gas as fuel. This mixture is combusted and drives the SIGT which in turn drives a generator to also produce an Electric Power output EP.
Steam from the HRSG is also sent to a Steam Turbine ST which drives a generator to produce Electric Power output EP.
The exhaust Steam from the ST is sent to a Condenser C where it is condensed into Sanitized and Sterile Water that may be (i) recycled to the combined cycle power plant, (ii) released to the WTP for distribution back to the Municipality M, or, (iii), discharged back to the Water Source WS.
Electric Power EP generated by this process, is distributed back to provide internal power for the Waste Water Energy Process with the remainder exported to the regional power grid RPG or other distribution network.
Waste Water being used in the process is substantially reducing the flow of effluent into the local rivers, while the Sanitized and Sterile residual water processed through the System is returned to the WTP, or released into the Water Source WS, making a significant contribution to the Sustainability of the Municipality, contributing to cleaning up our air, rivers and bays.

### Example 2

The Waste Water Energy Process in another embodiment of the invention intercepts the Treated Waste Water as it is discharged from the Waste Water Treatment Plant WWTP and feeds it to a Water Turbine WT which produces an Electric Power output EP.

The waste water exiting the water turbine is diverted back to the water source.

### Example 3

In another embodiment of the invention, only a WT, SIGT and HRSG are used to produce EP.

### Example 4

In another embodiment of the invention, the same system and method described in Example 1 is used except the water turbine is omitted. In this example, the details of the natural gas fired turbines will be presented in more detail. The system utilizes four combustion turbines each rated at 197 MW at 59 F to generate power. Two turbines will operate in combined-cycle mode. These combustion turbines will drive electric generators. Hot-exhaust gases from the two combustion turbines will each exhaust through a HRSG, generating steam to drive a single steam turbine and electric generator, thus increasing the total power produced to approximately 981 MW at ISO temperature of 59 F. The units will include state-of-the-art combustion technology and control equipment to limit air pollutant emissions. Natural gas is a clean burning fuel that when combusted generates minimal particulate and sulfur oxide emissions. Natural gas has the lowest Green house Gas (GHG) emission rate of all fossil fuels such as coal or fuel oil. The generation of emissions of nitrogen oxides (NOx) will be limited by the use of a dry low NOx combustion system. NOx emissions will be further controlled by the application of a selective catalytic reduction (SCR) control system on the exhaust from the HRSG. The SCR system will rely on aqueous ammonia injection. Aqueous ammonia consists of a solution of water (75%) and ammonia (25%). The rate of ammonia injection will be well controlled to effectively reduce NOx and limit ammonia slip or release to the air during operation of the SCR. The carbon monoxide (CO) emissions will be reduced by use of a CO oxidation catalyst. The use of these controls match the most stringent controls required for any combined cycle combustion turbine in the United States. The combined cycle units are expected to operate intermittently or continuously based on seasonal demand. Two of the four combustion turbines will operate as simple cycle peaking units, only operation during periods of high demand for electric power. The peaking units will also be designed to limit their environmental impact including the use of a dry low NOx combustion system and SCR to control NOx emissions.

Each of the four combustion turbines will vent through an exhaust stack. The exhaust stack heights will be designed to eliminate the potential for downwind air quality effects. The exhaust stacks will be low in profile.

In the preferred embodiment, the energy generating system comprises all of the elements described in Example 1 for maximum use of waste water.

Having now fully described the invention, it will be apparent to one of ordinary skill in the art that many changes and modifications can be made thereto without departing from the spirit or scope of the invention as set for the herein.

What is claimed is:

1. A waste water energy system for producing energy comprising: a waste water source and one or more electric power generating devices that take an input of waste water from the waste water source and produce electric power output(s).

2. The system of claim 1, wherein said one or more electric power generating devices comprise one or more of a water turbine, a gas turbine, and steam turbine.

3. The system of claim 1, wherein said one or more electric power generating devices comprise one or more of a water turbine and a combined cycle power plant.

4. The system of claim 1, wherein said waste water source comprises a waste water treatment plant for an industrial plant, a factory, or a polluted waterway.

5. The system of claim 1, wherein said system further comprises a grid for receiving said electric power outputs.

6. A waste water energy system for producing energy comprising:
a) a waste water source that produces waste water;
b) a water turbine for receiving said waste water and producing a first electric power output;
c) a gas turbine that utilizes said waste water from said water turbine for producing waste water steam and a second electric power output; and
d) a steam turbine for receiving said waste water steam from said gas turbine and producing a third electric power output.

7. The system of claim 6, further comprising a grid for receiving said electric power outputs.

8. The system of claim 6, wherein said steam turbine produces steam and wherein said system further comprises a condenser for receiving and condensing said steam from said steam turbine.

9. The system of claim 6, further comprising a heat recovery steam generator in association with said gas turbine and said steam turbine.

10. The system of claim 6, wherein said waste water source comprises a waste water treatment plant for an industrial plant, a factory, or a polluted waterway.

11. A waste water energy system for producing energy comprising:
a) a waste water source that produces waste water;
b) a water turbine for receiving said waste water and producing a first electric power output and an outflow of waste water;
c) a combined cycle power plant for receiving said outflow of waste water from said water turbine and producing additional electric power outputs.

12. The waste water energy system of claim 11, further comprising a grid for receiving said electric power outputs.

13. The system of claim 11, wherein said waste water source comprises a waste water treatment plant for an industrial plant, a factory, or a polluted waterway.

14. The system of claim 11, further comprising a condenser for receiving steam from said combined cycle power plant.

15. A waste water energy system for harnessing energy from waste water and converting it to electric power comprising:
a) a waste water source that produces waste water;
b) a water turbine for receiving said waste water and producing an electric power output.

16. The waste water energy system of claim 15, further comprising a grid for receiving said electric power outputs.

17. The system of claim 15, wherein said waste water source comprises a waste water treatment plant for an industrial plant, a factory, or a polluted waterway.

18. A waste water energy process for generating electric power using waste water and for reducing pollution in natural waterways comprising:
a) receiving waste water from a waste water treatment source;
b) providing an input of said waste water from a waste water source to one or more electric power generating devices that can utilize said waste water in the production of electric power outputs; and
c) producing electric power output(s) with said electric power generating devices.

19. The process of claim 18, wherein said electric power generating devices comprise one or more of a water turbine, gas turbine, a steam turbine and a combined cycle power plant.

20. The process of claim 18, wherein said waste water source comprises a waste water treatment plant for an industrial plant, a factory, or a polluted waterway.

21. The process of claim 18, wherein said electric power generating devices comprise a combination of a water turbine and a combined cycle power plant.

22. The process of claim 21, further comprising providing a condenser in association with the combined cycle plant.

23. The process of claim 18, wherein said electric power generating devices comprise a combination of a water turbine, gas turbine and steam turbine.

24. The process of claim 23, further comprising providing a condenser in association with the steam turbine.

25. The process of claim 18, wherein said electric power generating devices comprise a combination of a gas turbine and steam turbine.

26. The process of claim 25, further comprising providing a condenser in association with the steam turbine.

27. The process of claim 18, further comprising a step of sending said electric power output(s) from said electric power generating devices to a grid.

28. A waste water energy process for producing electric power and for reducing pollution in natural waterways comprising:
a) receiving a first output of waste water from a waste water source;
b) inputting said first output of waste water from a waste water source into a first electric power generating device, said first electric power generating device comprising a water turbine, said water turbine converting energy in said waste water into a first electric power output and further generating a second waste water output;
c) providing a heat recovery steam generator for receiving said second waste water output, said heat recovery steam generator converting said second waste water output into steam;
d) providing a gas turbine to receive a first amount of said steam from said heat recovery steam generator and utilizing said first amount of said steam in the production of a second electric power output; and
e) providing a steam turbine to receive said a second amount of said steam from said heat recovery steam generator and utilizing said second amount of steam for the production of a third electric power output.

29. A method of reducing waste water contaminants into less harmful or non-harmful bi-products comprising: running waste water from a waste water source though a gas turbine, steam turbine, combined cycle power plant and/or cooling tower.

30. A method of producing energy comprising:
circulating waste water from a waste water source through a cooling tower and sending it to one or more electric power generating devices such as a gas turbine, and/or a steam turbine.
